(19) United States
(12) Patent Application Publication
(10) Pub. No.: US 2025/0091526 A1
(43) Pub. Date: Mar. 20, 2025

(54) HOLDING APPARATUS FOR A MOBILE DEVICE IN A VEHICLE INTERIOR

(71) Applicant: Faurecia Innenraum Systeme GmbH, Hagenbach (DE)

(72) Inventors: Christophe Wagner, Salmbach (FR); Arthur Lemee Coupe, Javene (FR); Thiemo Stawinski, Landau (DE); Sabine LINDEMANN, Hagenbach (DE)

(21) Appl. No.: 18/817,685

(22) Filed: Aug. 28, 2024

(30) Foreign Application Priority Data
Sep. 15, 2023 (DE) 10 2023 209 003.1

(51) Int. Cl. B60R 11/02; B60R 11/00

(52) U.S. Cl. CPC B60R 11/0241; B60R 2011/0043

(57) ABSTRACT

A holding apparatus for holding a mobile device (such as a smartphone) in a vehicle interior can comprise a support element having a support surface for supporting the mobile device. The support element being movable along a first axis between a raised position and a lowered position. The holding apparatus can further comprise at least one holding element for reversibly holding and releasing the mobile device. The at least one holding element being movable along a second axis between a holding position for holding the mobile device and a release position for releasing the mobile device. The holding apparatus can further comprise a drive device configured to move the support element along the first axis and the at least one holding element along the second axis.

### CLAIM FOR PRIORITY

This application claims the benefit of priority of German Application No. 10 2023 209 003.1, filed Sep. 15, 2023, which is hereby incorporated by reference in its entirety.

### TECHNICAL FIELD

The present disclosure relates to a holding apparatus for holding a mobile device in a vehicle interior, in particular an electronic mobile device, for example a smartphone or tablet. The vehicle can in particular be a road vehicle and furthermore in particular a motor vehicle, in particular a car, a truck or a bus.

### BACKGROUND

Holding apparatuses for mobile telephones or tablets in vehicle interiors can include clamping apparatuses, in which the mobile telephone can be arranged. For this purpose, clamping jaws, for example, are arranged in a vehicle interior in such a way that they are visible to a vehicle occupant. The occupant can open the clamping jaws, arrange their mobile telephone between the clamping jaws and then close the clamping jaws.

### SUMMARY

Such holding apparatuses have, among other things, the disadvantage that they no longer meet the current design requirements in vehicle interiors. For example, they have many interfering contours that pose a risk of injury, particularly in the event of a crash. In addition, existing holding apparatuses do not always provide a sufficiently secure hold, especially during winding and/or bumpy journeys and/or in the event of an accident. Furthermore, existing holding apparatuses are usually not visually appealing, particularly due to the aforementioned interfering contours, and are characterized by unnatural-looking and, in particular, jerky movement sequences.

The present disclosure is therefore based on the object of overcoming at least one of the aforementioned disadvantages and providing a correspondingly improved solution for holding a mobile device. In particular, the present disclosure can be based on the object of providing a holding apparatus with an improved and, in particular, less contoured appearance and/or with more natural movement sequences and/or with a more reliable holding function.

According to a first aspect, a holding apparatus for a mobile device in a vehicle interior is proposed, in particular for a smartphone, wherein the holding can comprise:
a support element having a support surface for supporting the mobile device, wherein the support element is movable along a first axis between a raised position and a lowered position,
at least one holding element for reversibly holding and releasing the mobile device, wherein the holding element is movable along a second axis between a holding position for holding the mobile device and a release position for releasing the mobile device,
a drive device which is configured to move the support element and the holding element along the respective first and second axes.

The holding apparatus can be arranged in a region of the vehicle interior that is accessible from a driver's seat. For example, the holding apparatus can be arranged or can be arrangeable in a center console or in an instrument panel of the vehicle interior.

The support surface can be flat, at least in some areas. To ensure reliable support of the mobile device, the support surface can be dimensioned to be comparable to the base area of the mobile device. The support surface can, for example, comprise several 10 cm², for example at least 50 cm². In particular, the support surface can be substantially rectangular and/or oval in shape or have another elongated shape. The support surface can be aligned at least sectionally orthogonal to the first axis or at another angle thereto, which is preferably greater than 25°.

To reduce structural complexity, the holding apparatus can have only one support element and/or only one support surface for supporting the mobile device.

The raised position of the support element can also be referred to as first or as inactive position. The lowered position of the support element can also be referred to as second or as active position. The raising and lowering of the support element can be carried out relative to or, in other words, in relation to the vehicle interior and/or a user and/or from the user's perspective. For example, the lowering can be carried out relative to adjacent regions of the holding apparatus and/or the vehicle interior. In particular, the lowering can correspond to or comprise a retraction.

By lowering the support element, a receiving space can be provided or at least enlarged in which the mobile device can be placed. The support surface of the support element can in particular form or support a base area of this receiving space. By raising the support element, the receiving space can be reduced or completely eliminated. The receiving space may comprise or form a recess. By raising and lowering the support element, in particular a depth dimension of the receiving space can be varied, whereas a base area thereof can be fixed, for example, by or corresponding to a size of the support surface. In summary, by raising and lowering the support element, a receiving space of the holding apparatus for the mobile device can be reversibly enlarged or reduced and/or reversibly formed and eliminated.

The holding element can be movable in a plane that extends parallel to the support surface. The holding element can be configured to touch the mobile device or to support itself on it, in particular by generating a clamping force. Two holding elements can be provided, at least one of which can be movable. During the movement of at least one or both holding elements, a distance between the holding elements can be varied, in particular along the second axis. To assume the holding position, said distance is preferably reduced. To assume the release position, said distance is preferably increased.

If only one holding element is provided, said holding element can, for example, interact with an edge region of the holding apparatus and in particular with a receiving space for the mobile device enclosed thereby. For example, the individual holding element can press a mobile device against this edge region and thus clamp it.

The drive device preferably comprises at least one electric motor. Said electric motor or a plurality of electric motors can in particular be mechanically coupled to the holding element and/or the support element, for example by means of at least one gear stage. The drive device can be configured to hold and/or fix the holding element and/or support element in any position explained herein until a renewed movement of the holding element and/or support element is desired.

In one embodiment, the drive device can have exactly one single electric motor. Said single electric motor can in particular be mechanically coupled to the holding element and/or the support element, for example by means of at least one gear stage. The single electric motor can be configured to hold and/or fix the holding element and/or support element in any position explained herein until a renewed movement of the holding element and/or support element is desired.

The ability to raise and lower the support element allows interfering contours to be reduced, for example because lowering to create a receiving space is only possible when a mobile device is actually to be held by the holding apparatus. By means of the drive device, the movement sequences of the holding element and the support element can be coordinated and, in particular, can be carried out with uniform and less jerky accelerations. The holding element can be used to ensure a secure hold of the mobile device.

According to a further development, in the holding position at least one section of the holding element faces the support surface of the support element or, in other words, overlaps with it and/or engages over it. The facing can occur particularly when viewed along the first axis. Along said axis, the holding element and the support surface can enclose a gap between them in which the mobile device can be received. A relative arrangement of the holding element and the support surface according to one of these variants enables a large-area structural support as well as a secure holding of the mobile device in the holding apparatus.

The second axis, along which the holding element can be moved, can extend at an angle to the first axis, in particular at an angle of between at least 10° and up to 135°.

The holding element can be moved rotationally or translationally between the holding position and the release position. The translational variant enables the realization of a particularly secure holding effect with a compact structure. For example, the holding element can be displaced translationally, in particular parallel to the support surface. From the user's perspective, the holding element can in particular be moved into a holding position above the support surface in order, for example, to be able to hold the mobile device securely between the support surface and the holding element.

According to a further development, the holding element comprises a support section for supporting and thereby holding the mobile device. The support section can, for example, be encompassed by an end section (in particular when viewed along the second axis) and/or by a side of the holding element facing the mobile device. In particular, at least when assuming the holding position, the support section can be angled relative to the support surface of the support element, in particular by an angle of between at least 10° and up to 80°. In this way, a support surface of the holding element can be provided, with which secure support is ensured even with varying heights of the mobile device along the first axis. This applies in particular if, according to embodiments of the disclosure, the holding element is displaced translationally and, for example, at an angle to the first axis. Due to the beveled support section, said support section can be reliably supported, in particular at an edge or rim region of the mobile device, even when the support element is in a fixed lowered position, despite the varying height of the mobile device. Also, as a result of the beveling, clamping forces acting in the direction of the support surface can be generated.

The support section can have a flat and/or closed and/or recess-free and/or contour-free and/or locking lug-free surface facing the mobile device. This allows secure support on the mobile device despite its possibly varying dimensions.

According to a further embodiment, the holding element comprises at least one coupling section for coupling to the drive device, wherein the coupling section is opposite a rear side of the support element facing away from the support surface or, in other words, overlaps with this rear side. This can apply at least when the holding element is in the holding position. The coupling section can, for example, comprise a structure by means of which a force is transmitted from the drive device to the holding element. The structure may, for example, comprise a toothing or a projection for engaging in a control contour. In particular, the structure can be shaped like a toothed rack or may comprise a toothed rack. A driven element that is fixedly connected to the drive device, for example a gear or a coupling element described below, can engage in the structure.

By arranging this coupling section opposite and/or overlapping with the rear side of the support element, a compact structure of the holding apparatus can be provided. In particular, the drive device can also be arranged at least partially opposite and/or overlapping with the rear side of the support element. For example, the drive device can comprise an electric motor whose rotation axis extends parallel to the first axis.

If a plurality of holding elements is provided, said holding elements can generally be of the same design, but can be shaped and/or arranged in a mirror-symmetrical manner, for example. In particular, both holding elements can comprise coupling sections that are arranged opposite to the rear side of the support element. Said coupling sections can face one another. They may enclose an element driven by the drive device therebetween, in particular a gear or a coupling element disclosed herein. Such a gear can, for example, be in engagement with toothings of both coupling sections, wherein said coupling sections can engage on different and in particular mutually opposite outer circumferential regions of the gear. Such an arrangement also improves the compactness of the holding apparatus, especially since both holding elements are moved by only one electric motor.

In a further embodiment, the holding apparatus further comprises a frame element with a front side facing the vehicle interior. The frame element can also be referred to as a cover element or as a general upper side element. The support element can be arranged in particular in its raised position in alignment or, in other words, flush with the front side of the frame element. In particular, the support element can be arranged in a common plane with the front side. This reduces interfering contours of the holding apparatus, in particular in an inactive state thereof. The frame element can extend adjacent to at least two—in particular opposite—sides of the support element or enclose the support element in a frame-like manner. In particular, sides or edges of the support surface of the support element can be considered, adjacent to which the frame element can extend accordingly.

The frame element can be immovable. It can define a uniformly shaped and/or contour-free surface with the support element, at least when said support element is in the raised position. When the support element is lowered, a receiving space for the mobile device can be formed, which can be surrounded by the frame element at least sectionally or completely.

In a further embodiment, at least one section of the frame element is located opposite the support element in such a way that, when moving along the first axis, the support element is supported on this section with at least in some areas reversible deformation of the frame element. In particular, the frame element can be deformed and, for example, bent in certain areas by said support element when the support element is lowered. When the support element is moved back to the raised position, its support on the frame element can be eliminated or at least reduced. The deformation of the frame element can then be reduced or eliminated accordingly. Figuratively speaking, the frame element can be brought into a form that is bent downwards at least in some areas and/or pressed downwards locally by the support element. This can result in more uniform transitions from adjacent regions of the vehicle interior to the holding apparatus, in particular when the holding apparatus is holding a mobile device. In particular, this can reduce sharply contoured transitions, for example between the receiving space for the mobile device and adjacent regions of the holding apparatus and/or the vehicle interior.

To achieve a desired deformability, the frame element can have regions with locally increased deformability and/or with a joint-like function. These regions may, for example, have a reduced material thickness and/or local incisions and/or recesses. Alternatively or additionally, a material of the frame element can have a correspondingly high degree of flexibility with which the desired deformability can be achieved. According to a variant with reliable deformability, the frame element is divided into a plurality of deformation sections when viewed in a direction surrounding the support element, which are each separated from one another at least in some areas by a cut.

The frame element can have a recess in which the holding element is at least partially arranged. If two holding elements are provided, the frame element can accordingly have two such recesses. The frame element can be deformable in particular around the holding elements in the manner described above, whereas the holding elements are preferably not deformable. In this way, a reliable function of the holding elements can be combined with the optional deformability of the frame element

According to another embodiment, the frame element covers the at least one holding element from the user's perspective. In this case in particular, the frame element can have a lid or covering function. From the user's perspective, the holding element can be positioned below the frame element and, in particular in its release position, can be largely or completely concealed by the frame element. To assume the holding position, the holding elements can be displaced relative to the frame element and thus become visible to a greater extent in particular.

In a further development, the holding element, viewed along the second axis, comprises a first end section which, when moving into the holding position, is movable relative to an adjacent region of the holding apparatus and in particular away from it. This adjacent region may be immobile. It can, for example, be enclosed by the frame element or another element of the holding apparatus. Opposite the first end section, the holding element can have a second end section. Said second end section can be configured for a support on the mobile device and/or to face it. For example, it can have the beveled support surface mentioned above.

The first end section and the adjacent region may be shaped to complement each other, at least sectionally. In particular, they can be shaped in such a way that, at least when the release position is assumed, the first end section and the adjacent region can be received into one another at least sectionally or, in other words, are in engagement with one another. This can comprise that at least one of the first end section and the adjacent region has at least one section in which a complementary shaped section of the corresponding other of the first end section and the adjacent region can be received. For example, these sections can be designed as a projection and a complementary shaped recess.

In particular, the first end section and the adjacent region can be received in or engage with one another, at least in the release position, but without necessarily contacting one another. Thus, a kind of form closure can be formed between these structures, but without said form closure necessarily requiring contact between them.

Preferably, the first end section and the adjacent region are still at least partially received in one another or are still in engagement with one another even in the release position. For example, the engagement can always be maintained during a movement between the holding position and the release position.

By receiving in one another and/or engaging with one another at least sectionally, the formation of a gap of pronounced length between the first end section and the opposite region is prevented. A width of such a gap may extend along the second axis. A length of the gap may run at an angle to the second axis and, for example, orthogonal thereto. In particular, a length of the gap can be measured in a plane that runs orthogonal to the first axis along which the support element is movable.

The formation of a pronounced gap of, for example, several centimeters and in particular more than 5 cm in length, which can be prevented with the embodiments disclosed here, could define undesirable interfering contours and/or clamping risks. Moreover, if a covering skin is provided according to the embodiments below, such a gap could define a region with only weak structural support for the covering skin.

According to a further embodiment, the first end section and the adjacent region each have a toothing, wherein these toothings are in particular shaped complementary to one another. The toothings may be engageable with one another or may be in engagement with one another, wherein the latter is preferably given both in the holding position and in the release position. The toothings can also be referred to as comb-like structures or have such a comb-like shape.

In a further embodiment, the drive device has a first electric motor for moving the support element and a second electric motor for moving the at least one holding element and preferably all of the holding elements, provided that a corresponding plurality is provided. This can enable a reliable drive of the support element and the holding element, in particular in the case of a less complex coupling with a respective electric motor.

Alternatively, the drive device can comprise one electric motor for generating the movements of both the support element and the holding element. This electric motor can, for example, be configured to rotate a coupling element which is coupled to both the support element and the holding element. In accordance with a rotation of the coupling element, it can transmit movement forces to both the support element and the holding element. Consequently, all movements of the holding apparatus can be generated with a small number of parts.

In this context, it may be provided that one of the coupling element and the support element has a first control contour on which the corresponding other of the support element and the coupling element is supported. Additionally or alternatively, one of the coupling element and the holding element can have a second control contour on which the corresponding other of the holding element and the coupling element is supported. In this case, movement forces for moving the corresponding support element and holding element can be generated by means of the first and second control contours and in accordance with a rotation of the coupling element.

The first and second control contours can, for example, each comprise a groove or a recess. However, it can also be designed as an elongated projection, for example. The support can be achieved in particular by engaging in a groove-shaped control contour, for example, or by resting against a projection-like control contour. For this purpose, a projecting region can be provided, for example a pin-like projection. If the coupling element is rotated, a control contour comprised therein or a support structure comprised therein can transmit forces to the support element or holding element. The control contour can be used to guide and/or align these forces in such a way that the desired movements can be achieved.

In other words, a cam mechanism can be formed by means of the coupling element, in particular with a groove guide, which can be provided by a respective control contour.

The control contours can be designed such that the holding element and support element are only moved at certain angles of rotation and in particular can be moved successively and/or independently of one another. For this purpose, the first and/or second control contour can, for example, also comprise sections which, at least in certain rotation angle ranges of the coupling element, do not transmit any movement forces to the correspondingly coupled support element or holding element. These sections can, for example, have a constant height or position along a rotation axis of the coupling element and/or a constant radius around the rotation axis. To generate movements, sections can further be provided which have correspondingly varying heights or positions and/or radii. Sections with and without movement generation can follow one another within a respective control contour in such a way that movements are generated or not generated within the desired rotation angle ranges of the coupling element. This can be used in particular to generate movements in a rotation angle range of the coupling element by means of only one of the control contours in order to move the support element and the holding element exclusively sequentially, but not simultaneously.

In general, the holding apparatus can be configured to move the support element in the direction of the lowered position and in particular until this lowered position is reached before the holding element is moved into the holding position. To release the mobile device, however, the holding element can preferably first be moved completely into the release position before the support element is moved into the raised position.

According to a variant, the coupling element, at a first surface thereof, is coupled to the holding element and, at a second surface thereof, to the support element, wherein the first and the second surface can be different from one another and/or can face away from one another. In particular, they can run at an angle of, for example, between at least 45° and up to 90° to one another. For example, the coupling element can be circular-cylindrical and the first surface can be a cylinder base area and the second surface can be a lateral surface of a cylinder. In each of the first and second surfaces, control contours of the type disclosed herein may be provided for coupling to the support element or holding element. It has been shown that by means of a coupling element designed in this way, the desired movements can be reliably generated with a compact structure of the coupling element.

The drive device or the holding apparatus in general may comprise at least one control device, for example comprising a processor. The control device may be configured to control at least one electric motor or another drive unit of the drive device for generating the respective movements of the holding element and the support element. Additionally or alternatively, the control device may be configured to receive and evaluate signals from any sensors explained below, in particular in order to control the drive device based thereon.

According to a further embodiment, the holding apparatus also has a sensor arrangement with:
at least one first sensor, in particular a proximity sensor, wherein the first sensor is configured to generate measurement signals by means of (or based on) which it can be recognized whether a user wants to insert a mobile device into the holding apparatus (for example because the user is approaching with a mobile device) and/or wants to remove it from the holding apparatus (for example because the hand of the user is approaching the holding apparatus);
at least one second sensor which is configured to generate measurement signals by means of which it can be detected whether a mobile device is present in the holding apparatus.

The first sensor can be designed such that it can sense whether a user is moving a mobile device, in particular a smartphone or tablet, in the direction of the holding apparatus. If this is the case, the holding apparatus can move the support element to the lowered position and/or the holding element to the holding position. In particular, the holding element can be moved into the holding position at least when the second sensor detects that a mobile device is present in the holding apparatus.

Two first sensors can also be provided, one of which is configured to detect whether a user wants to insert a mobile device into the holding apparatus, and another is configured to detect whether a user wants to remove a mobile device from the holding apparatus. These two first sensors can be positioned at a distance from one another.

The two first sensors or any sensor of the sensor arrangement can be evaluated and/or activated by a control unit mentioned herein in particular only if a defined condition is met. In particular, at least selected sensors of the sensor arrangement can be activated and/or evaluated sequentially, but not simultaneously, wherein the sequence of activating and/or evaluating can in turn be controlled based on defined conditions. By activating and/or evaluating the sensors under certain conditions or only in specific situations, false detections can be prevented and energy consumption can be reduced.

For example, the second sensor can only be activated and/or evaluated if it has previously been detected based on measurement signals from the first sensor that a mobile device is to be placed in the holding apparatus. Additionally or alternatively, a first sensor for detecting whether a mobile device is to be removed from the holding apparatus can only be activated and/or evaluated if it has previously been detected that a mobile device is to be placed in the holding apparatus and/or a mobile device is actually placed in the holding apparatus.

If only one first sensor is provided, its measurement signals can be used, in particular if no mobile device has yet been placed in the holding apparatus, which can be detected, for example, by a corresponding query of the second sensor, to detect that a mobile device is to be placed in the holding apparatus. Subsequently, based on its measurement signals and upon further approach and/or upon approach when a mobile device is placed in the holding apparatus, which in turn can be detected, for example, by corresponding query of the second sensor, it can be detected that a mobile device is to be removed from the holding apparatus.

If reference is made herein to detection by means of or based on measurement signals from the sensors, this can comprise or be equivalent to the fact that the sensors are configured to generate measurement signals on the basis of which a control device can determine and thereby detect the corresponding state.

Any proximity sensor mentioned herein may be an optical proximity sensor, but in particular a capacitive proximity sensor. The second sensor can, for example, be arranged in the support element and/or can be a pressure sensor, a weight sensor or a proximity sensor.

In a further variant, the holding apparatus also comprises a covering skin which has a front side facing the vehicle interior and a rear side facing away from the vehicle interior. Preferably, the covering skin conceals at least the support element from the vehicle interior and/or is connected thereto for a common movement. In particular, the rear side can therefore face the support element and/or the support element can be arranged on or near the rear side. Additionally or alternatively, the covering skin can conceal the holding element from the vehicle interior and/or can be connected thereto for a common movement.

The covering skin can help to conceal interfering contours of the holding apparatus, prevent contamination of the holding apparatus or reduce the risk of clamping caused by it. Furthermore, the covering skin, which can generally be deformable in accordance with movements of the support element and/or the holding element, can contribute to making the movement sequences of the holding apparatus appear more uniform and/or natural from the user's perspective. For example, it can at least somewhat dampen jerky movements and/or make movements only partially visible.

A receiving space of the holding apparatus, which can be enlarged by lowering the support element, can be covered with the covering skin, preferably completely. In particular, the covering skin can span the receiving space and/or line the inner walls thereof. When the support element is lowered, the covering skin can be lowered together with it so that the receiving space is not closed off by the covering skin.

The covering skin can cover the support element and/or the holding element and in particular any receiving space in such a way that these each are not visible from a vehicle interior, in particular when the support element is in a raised position and/or the holding element is in a release position. In particular, only a flat and/or evenly shaped surface of the covering skin can be visible to a user in the vehicle interior. When the holding element moves into the holding position and/or the support element moves into the lowered position, the covering skin can move with it and/or deform according to its movement. In this case, the covering skin can be deformed according to a shape of the receiving space thus enlarged.

In one example, the covering skin is designed to be elastic. In a resting state of the holding apparatus without a mobile device inserted, with the support element in the raised position and with the holding element in the release position, the covering skin can have a first deformation state and/or first elastic stretching state. In a holding state of the holding apparatus with the mobile device inserted, with the support element in the lowered position and with the holding element in the holding position, the covering skin can have a second, comparatively more pronounced deformation state and/or a second, comparatively more pronounced stretching state.

The position of the support element located under the covering skin can be made visible on the covering skin. For example, the covering skin can have a different color in this region than in the surrounding region. Additionally or alternatively, lettering or a symbol can be applied to the covering skin and/or a different material can be used. Additionally or alternatively, non-elastic facets can be applied to the covering skin at least in this region. The covering skin can additionally or alternatively be formed by non-elastic facets with elastic material arranged in between. The covering skin can be backlit in the region in which the receiving space is arranged. For this purpose, for example an illuminant, for example in the form of LEDs, can be provided. For this purpose, the covering skin can, for example, be at least partially translucent.

In one embodiment, the covering skin can be arranged in the region of the support element so as to overlap itself sectionally and in particular be folded, in particular if the covering skin is intended to cover or conceal the support element. For example, the covering skin can be folded when the support element is in the raised position. The folding can be designed such that it is visible to a vehicle occupant, in particular so that, by means of the folding, the vehicle occupant can locate where the receiving space is located under the covering skin. Alternatively, the folding can be designed such that it is not visible or only slightly visible to a vehicle occupant. A visible surface can then seem or be flat. The folding can be at least partially released and/or unfolded in accordance with a movement of the support element into the lowered position. In particular, the covering skin can be unfolded to a greater extent when the support element is in the lowered position.

If the covering skin is designed to be elastic or has elastic regions, the covering skin is preferably elastically stretched when the supporting element is moved into the lowered position and/or the holding element is moved into the holding position. In a resting state of the holding apparatus as mentioned above, this elastic stretching may be less or the covering skin may not be elastically stretched.

The covering skin can comprise, for example, a film or a textile. For example, the covering skin can comprise leather and/or artificial leather. The covering skin can comprise a plurality of layers of different materials. For example, the covering skin can comprise leather, a woven fabric, a knitted fabric, polyvinyl chloride (PVC), or polyurethane (PU).

According to a second aspect, the present disclosure also relates to a holding apparatus for holding a mobile device in a vehicle interior, in particular for holding a smartphone, wherein the holding apparatus comprises:
a support element having a support surface for supporting the mobile device, wherein the support element is optionally movable along an (in particular first) axis between a raised position and a lowered position,
at least one holding element for reversibly holding and releasing the mobile device, wherein the holding element is movable along an (in particular second) axis between a holding position for holding the mobile device and a release position for releasing the mobile device,
a drive device configured to move the holding element along its axis and optionally to move the support element along its axis.

In this second aspect, it can be provided that the holding element, viewed along the second axis, comprises a first end section which, when moved into the holding position, is movable relative to an opposite region of the holding apparatus, wherein at least when the release position is assumed, the first end section and the adjacent region can be received into one another at least sectionally.

All of the embodiments and further developments of the holding apparatus of the first aspect disclosed herein can also be provided in combination with this second aspect. This relates in particular to all embodiments and variants in the context of the first end section. In particular, in the context of the second aspect, the first end section and the adjacent region can be shaped complementary at least sectionally, in particular wherein the complementary shaped sections of the first end section and the opposite region can each have a toothing.

### BRIEF DESCRIPTION OF THE DRAWINGS

Embodiments of the present disclosure are described below with reference to the accompanying schematic figures. The same reference signs can be used for identical or comparable features across all figures. The drawings illustrate generally, by way of example, but not by way of limitation, various embodiments discussed in the present document.

FIG. 1 illustrates an example of a holding apparatus according to a first embodiment in an exploded view.

FIG. 2 illustrates an example of the holding apparatus of FIG. 1 in a resting state.

FIG. 3 illustrates an example of the holding apparatus of FIG. 1 in a holding state, but for illustration purposes without a mobile device being held.

FIG. 4 illustrates an example of a holding element of the holding apparatus of FIG. 1 in a side view of the individual parts.

FIG. 5 illustrates an example of a holding apparatus according to a second embodiment in a perspective view.

FIG. 6 illustrates an example of the holding apparatus of FIG. 5 without a frame element.

FIG. 7 illustrates an example of details of the holding apparatus of FIG. 5 and in particular a drive device thereof.

FIGS. 8 and 9 illustrate an example of a coupling element of the holding apparatus of FIG. 5 in a perspective (side) view (FIG. 8) and in a plane view from above (FIG. 9).

### DETAILED DESCRIPTION

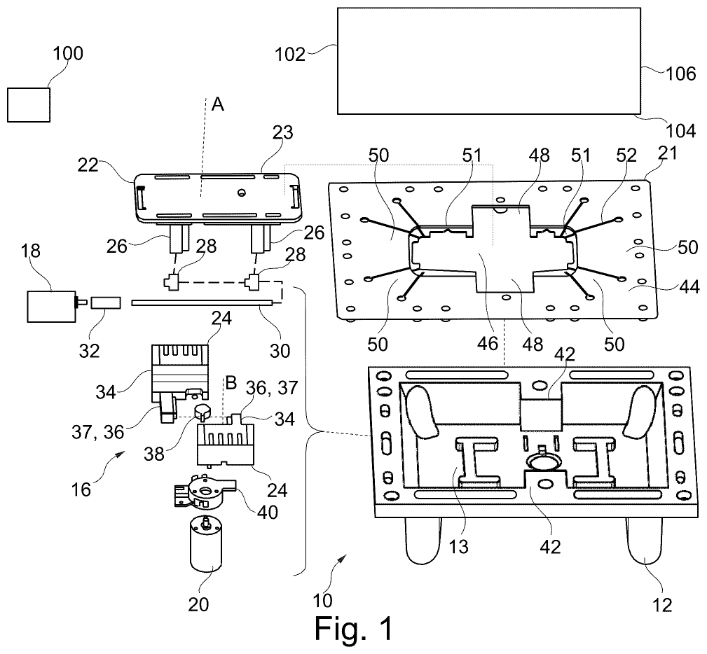

FIG. 1 is a schematic exploded view of a holding apparatus 10 according to a first exemplary embodiment. The individual components of the holding apparatus 10 are shown, wherein assembly relationships or general relative arrangements of individual components or assemblies formed therefrom are indicated schematically by means of dashed lines.

The holding apparatus 10 comprises an optional carrier element 12. Said carrier element defines an assembly space 13 for various components of the holding apparatus 10. In the orientation shown, this assembly space 13 is open towards a vehicle interior not shown separately. A drive device 16 is accommodated in the assembly space 13. Said drive device comprises two electric motors 18, 20. A first electric motor 18 is configured to move a support element 22 in a manner described below. A second electric motor 20 is configured to move at least one and, in the depicted exemplary embodiment, two holding elements 24 in the manner described below.

The support element 22 has a support surface 23 which is only by way of example substantially flat. Said support surface faces the vehicle interior, which is not shown separately. Furthermore, the support element 22 comprises two toothed rack sections 26 which run substantially orthogonally to the support surface 23 as a coupling section 37 for coupling to the drive device 16. A gear 28 of the drive device 16 engages in each of these. The gears 28 are held in a rotationally fixed manner on a shaft 30, wherein the shaft 30 is connected to the first electric motor 18 via an optional coupling piece 32. When the shaft 30 and thus the gears 28 rotate about a horizontal rotation axis which is not shown separately, the support element 22 can be moved up and down along a first movement axis A shown.

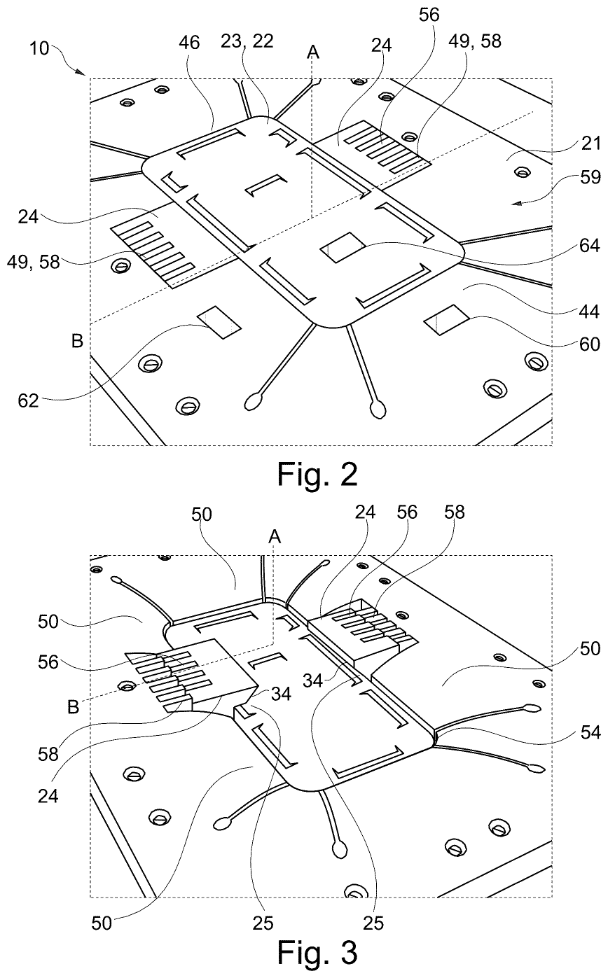

The holding elements 24 each have a support section 34, which will be explained in more detail below. The support sections 34 of the holding elements 24 are opposite one another. Furthermore, the holding elements 24 each have a toothed rack section 36 as a coupling section 37 for coupling to the drive device 16. Said toothed rack sections are in engagement with a gear 38 and, more precisely, are in contact with different regions of an outer peripheral surface of the gear 38. The gear 38 is connected to the second electric motor 20 via an optional coupling piece 40. The electric motor 20 is configured to rotate the gear 38 about a vertical rotation axis not shown separately. As a result, the holding elements 24 can be moved towards one another and away from one another along a second axis B, which, for example, runs orthogonally to the first axis A (see also FIG. 2).

In the example shown, the holding elements 24 optionally rest on support sections 42 of the carrier element 12. Not shown in FIG. 1, but explained below, are counterparts 49 with which the holding elements 24 can engage (see FIGS. 2 and 3 discussed below).

The holding apparatus 10 also comprises a frame element 44. Said frame element is plate-shaped and/or flat and, in the state shown, is designed to be substantially flat. The frame element 44 has a central recess 46. On the one hand, said recess is positioned analogously to the support surface 23, but optionally also has regions 48 for receiving the holding elements 24. The recess 46 has a plurality of overlap sections 51 which are opposite a rear side of the support surface 23 or, in other words, overlap therewith. The support element 22 can apply forces to this overlap section 51, in particular when it is moved to a lowered position.

The frame element 44 is made of a flexible material, in particular of a plastic. This material is in principle dimensionally stable and in particular stiffer than an optional cover 102. The frame element 44 comprises a plurality of individual deformation sections 50 which are distributed along the circumference of the recess 46 and selected ones of which are provided with a corresponding reference sign 50. The deformation sections 50 are each separated from one another by elongated slot-like recesses 52, whereby the deformability and more precisely the flexibility of the deformation sections 50 are specifically increased, in particular in directions along the first axis A shown.

Finally, a control device 100 of the holding apparatus 10 is also indicated in FIG. 1. Said control device is configured to generate control signals for controlling the electric motors 18, 20, for which purpose it is connected to the electric motors 18, 20 via lines not shown. Furthermore, the control device 100 is also connected to the sensors 60-64 explained below with reference to FIG. 2 via lines not shown separately.

FIG. 2 shows the assembled holding apparatus 10 of FIG. 1 in a perspective view and with a view of the support surface 23 and a front side of the frame element 21. It can be seen that the support element 22 or its support surface 23 fills the recess 46 of the frame element 21. In FIG. 2, the holding apparatus 10 is shown in a resting state. In said state, the support element 22 is in a raised position in which the front side of the frame element 21 and the support surface 23 are aligned with one another or, in other words, lie in a common plane. Consequently, they form a flat front side of the holding apparatus 10, which faces the vehicle interior. The holding elements 24 and, more precisely, their outer sides facing the vehicle interior also lie in this common plane. In the resting state shown, the holding elements 24 assume a release position. In said position, they do not overlap with the support surface 22 and fill the regions 48 of the recess 46 shown in FIG. 1. The first and second axes A, B of FIG. 1 are also shown in FIG. 2

In the resting state shown, the support surface 23 and more precisely its rear side does not exert any significant deformation forces on the overlap sections 51 of the frame element 21 shown in FIG. 1. The frame element 21 is therefore in an undeformed state.

FIG. 3 shows the holding apparatus 10 in a holding state. In said state, it can hold a mobile device (not shown) securely even during significant vehicle movements. In the holding state shown, the support element 22 and thus also its support surface 23 have been lowered along the first axis A relative to the vehicle interior and the state shown in FIG. 2. A recessed receiving space 54 is thus created opposite adjacent regions of the vehicle interior and, for example, an edge of the frame element 21 fixed to such adjacent regions. The support surface 23 forms a base area of this receiving space 54. The receiving space 54 is laterally limited by the frame element 21. In the exemplary embodiment shown, this is achieved by the downwardly bent deformation sections 50, see also FIG. 1. While these deformation sections 50 are undeformed and flat in FIG. 1, they are bent downwards along the first axis A in FIG. 3. This results from forces that the support element 22 applies to the overlap sections 51 of FIG. 1 during its lowering. The mobile device (not shown) can be placed on the lowered support surface 23 and thus in the receiving space 54.

Compared to the state in FIG. 2, the holding elements 24 have been moved towards one another along the second axis B. While the holding elements 24 in FIG. 2 assume their release position, in FIG. 3 they assume their holding position for holding the mobile device (not shown) on the support surface 23.

A distance between the opposing support sections 34 of the holding elements 24 is correspondingly reduced in the holding position of FIG. 3 compared to the release position of FIG. 2. The holding elements 24 are also located opposite the support surface 23, for example when viewed along the first axis A. In other words, they overlap the support surface 23 at least in some regions. This creates a gap 25 between the support surface 23, in which the mobile device (not shown) and in particular an outer edge thereof can be received sectionally. The holding elements 24 can also clamp the mobile device between them, i.e., press it in the direction of the opposing holding element 24 and clamp it against the latter.

It is further shown that the holding elements 24 have end sections 56 which face away from the support sections 34. In particular, these end sections 56 can form rear sides of the holding elements 24 facing the frame element 21.

In the example shown, a respective region 58 facing one of these end sections 56 and in particular opposite and/or adjacent thereto, is encompassed by one of the optional counterparts 49. In FIG. 2, each adjacent region 58 is engaged with one of the end sections 56 of one of the holding elements 24. For this purpose, the adjacent region 58 and end section 56 are complementary shaped and in particular complementary profiled and/or complementary toothed.

As can be seen from FIG. 3, this engagement is at least partially maintained when the release position is assumed, i.e., the adjacent regions 58 and an end portion 56 respectively engaged therewith are not completely disengaged and/or lifted away from one another. This prevents a large continuous gap from forming between the holding elements 24 and the frame element 21 when the release position is assumed. This gap would, for example, have similar dimensions to the counterparts 49 shown in FIG. 3. Such a hypothetically released gap would, for example, create a risk of injury due to the possibility of a user's fingers becoming trapped and is associated with various other disadvantages mentioned above.

The movement from FIG. 2 to FIG. 3 is preferably carried out in such a way that first the support surface 23 is first moved completely into the lowered position, whereupon the holding elements 24 are moved into their holding position. To release the mobile device, the movement sequence is reversed. This means that the holding elements 24 are first moved into their release position before the support surface 23 is raised back to its position shown in FIG. 2.

FIG. 2 further shows a sensor arrangement 59 of the holding apparatus 10. The sensor arrangement 59 comprises a first sensor 60 which is arranged in the region of the frame element 21, for example directly below it or integrated into it. Furthermore, the sensor arrangement 59 comprises a further sensor 62, which is also arranged in the region of the frame element 21 and at a distance from the first sensor 60. Finally, a third sensor 64 is also shown, which is arranged in the region of the support surface 23 and, for example, directly below it or integrated into it. The sensors 60-64 shown are capacitive proximity sensors, but this is not mandatory.

The first sensor 60 is configured to detect an approach of a mobile device to the holding apparatus 10, for example by sensing the approach of a metallic housing (or other metallic components) of the mobile device. When the control device 100 of FIG. 1 has detected this based on the sensor signals of the first sensor 60, the support element 22 is moved into the lowered position of FIG. 3. It should be noted that in the resting state of FIG. 2, preferably only sensor signals from the first sensor 60 are detected and/or evaluated.

Optional conditions can be defined so that the sensor signals of the first sensor 60 can be detected and/or evaluated. For example, it can be defined as a condition that a mobile device must be paired with a communication device of the vehicle, for example via Bluetooth or another wireless connection. Additionally or alternatively, conditions can be defined so that an approach is actually interpreted as a hold request by the control device 100. For example, a condition can define a minimum duration of a state of approaching the first sensor 60 of, for example, several seconds, i.e., the first sensor 60 must continuously detect an approach over a corresponding minimum duration.

When the support element 22 has been lowered, detection and/or evaluation of sensor signals is preferably limited to the second sensor 64. Said second sensor is configured to detect the presence of a mobile device in the region of the support surface 23. If this has been detected accordingly, the holding elements 24 are controlled by the control device 100 to assume the holding position of FIG. 3.

If the mobile device is consequently held in the holding apparatus 10, a detection and/or evaluation of sensor signals is preferably limited to the further sensor 62. Said further sensor is configured to detect the approach of a user's hand. This can be recognized as a release request of the mobile device, whereupon the holding apparatus 10 can be returned to its state of FIG. 2. In this case, too, conditions for recognizing the release request can be defined. For example, a minimum duration of a state of approaching the further sensor 62 of, for example, several seconds can be specified, i.e., the further sensor 62 must continuously detect an approach over a corresponding minimum duration.

Instead of the first and further sensors 60, 62, only one of these sensors 60, 62 can be provided. Depending on the operating state, approaches of a user's hand, for example, detected by said sensor, can be interpreted by the control device 100 either as a hold request (in particular when the mobile device is not yet held) or as a release request (in particular when the mobile device is held).

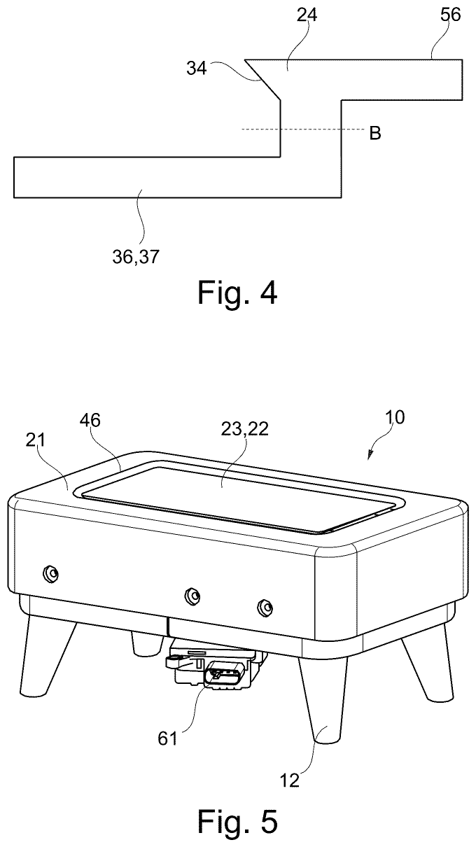

Finally, FIG. 4 shows one of the holding elements 24 of the holding apparatus 10 in an individual part representation and in a side view. A position of the second axis B is shown for orientation purposes. Also shown are the support section 34 and the end section 56, as explained with reference to the preceding figures. It is shown that the support section 34 is beveled, in particular with respect to the support surface 23 not shown separately in FIG. 4. This enables reliable contacting of an edge region of a mobile device 3, even if it has an unpredictable height relative to the lowered support surface 23.

Furthermore, it can be seen from FIG. 4 that the toothed rack section 36, which forms a coupling section 37 of the holding element 24 with the drive device 16, is elongated along the second axis B. Accordingly, it lies opposite a rear side of the support surface 23 or overlaps therewith, which is not shown separately, but can be seen from a combined view with FIG. 3.

Returning to FIG. 1, it is further shown there that the holding apparatus 10 of the first embodiment can optionally also have a covering skin 102, which preferably completely spans the frame element 21 and thus also conceals the support element 22 and the holding elements 24 from the user's perspective. FIG. 1 shows that a rear side 104 of the covering skin 102 faces the frame element 21 and the support element 22, while a front side 106 faces the vehicle interior. The area of the covering skin 102 is not limited to the area of the frame element 21. Instead, the covering skin 102 can transition continuously into a covering skin of the vehicle interior or can form an integral section thereof.

In particular, the covering skin 102 is connected, for example glued, to the support surface 23 but also to the deformation sections 50 of the frame element 44 for a common movement. Such a connection and in particular bonding can only be carried out locally in order to reduce expansion peaks within the covering skin 102. In particular, bonding can only be carried out with the outer edge regions of the frame element 44, but there also, optionally, only sectionally and not in a continuous circumferential manner.

Optionally, such a connection can also be made with the holding elements 24. Alternatively, the holding elements 24 can reversibly deform the covering skin as part of their movements, despite the lack of a fixed connection to the covering skin 102. Even when the covering skin 102 is provided, the receiving space 54 of FIG. 3 can thus be formed and a mobile device can be held and in particular clamped therein by means of the holding elements 24.

FIG. 5 shows a holding apparatus 10 according to a further embodiment. The holding apparatus 10 is in the resting state. It in turn has a carrier element 12 analogous to the first embodiment. Additionally shown is a connection device 61 of a drive device 16 of the holding apparatus 10 for electrical and/or signal-transmitting connection to other vehicle devices.

The carrier element 12 is largely concealed on the upper side by a frame element 21. An upper side of the frame element 21 is preferably arranged flush or, in other words, aligned with adjacent surfaces of the vehicle interior, which is otherwise not shown. What is not shown separately is that in the second embodiment, too, a covering skin analogous to the variant in FIG. 1 can in principle be provided.

In the variant shown in FIG. 5, the frame element 21 is not plate-shaped, but three-dimensional and in particular shaped like a lid or shell. The frame element 21 in turn has a central recess 46. Said central recess surrounds a support surface 23 of a support element 22. In contrast to the first embodiment, the frame element 21 is dimensioned such that it conceals the holding elements 24 shown below from the user's perspective, at least when the support element 22 is in the raised position shown in FIG. 5. Consequently, an engaging structure comprising end sections 56 of the holding elements 24 and the adjacent regions 58 according to the first embodiment is not absolutely necessary and is not present in the example shown.

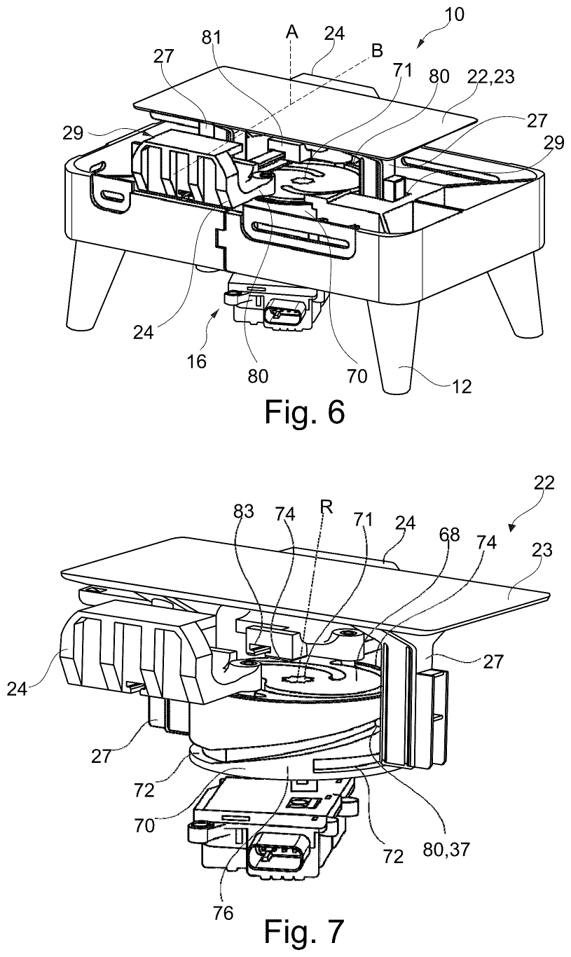

FIG. 6 shows the holding apparatus 10 of FIG. 5 with the frame element 21 removed. It can be seen that the support element 22, which is designed analogously to the first embodiment, is designed with two rear coupling webs 27. In principle, only one coupling web 27 could be provided. The support element 22 can in turn be lowered along an axis A shown. The coupling webs 27 are each accommodated in tunnel-like guide spaces 29, which guide the movements of the coupling webs 27 along axis A.

Furthermore, the holding elements 24 can be seen. By way of example, two holding elements 24 are provided, although only one can also be present. The holding elements 24 are shown in their release position. They can be moved towards one another along an axis B in order to assume their holding position.

In FIG. 6, a coupling element 70 of the drive device 16 is also partially visible. Said coupling device is explained in more detail using the detailed illustration in FIG. 7, in which the carrier element 12 of FIG. 6 is removed.

FIG. 7 shows that the coupling element 70 has a plurality of control contours 72, 74 in order to generate the desired movements of the support element 22 and the holding elements 24. The control contours 72, 74 are each designed as grooves. The substantially cylindrical coupling element 70 is coupled to an electric motor (not shown separately) of the drive device 16 and can be rotated by said electric motor about a rotation axis R. For this purpose, the coupling element 70 centrally accommodates a drive shaft 71 of the electric motor, wherein the drive shaft 71 is rotatably mounted in the carrier element 12 in a manner not shown in detail.

One of the cylindrical base areas 68 of the coupling element 70 faces the rear side of the support element 22. A lateral surface of a cylinder 76 or outer circumferential surface is opposite the coupling webs 27 of the support element 22.

The holding elements 24 each engage in one of the control contours 74 on the base area 68 and are thereby supported in particular on the side walls of the control contours 74. To achieve this engagement, the holding elements 24 have pin-like projections 80, which can also be referred to as support sections and which form the coupling sections 37 for coupling to the drive device 16. As will become clear from the following description, the projections 80 are located opposite a rear side of the support element 22 at the latest when the holding position is reached.

The holding elements 24 are also each in engagement with a guide rail 81 which guides the movement of the holding elements 24 along axis B. In FIG. 7, an engagement section 83 of one of the holding elements 24 for engaging with the guide rail 81 can be seen.

The support element 22 and more precisely its coupling webs 27 also have coupling sections 37 in the form of pin-like projections 80, via which they engage in the control contour 72 which is located opposite each of them and is designed as a guide groove. This can be seen in FIG. 7 for one of the coupling webs 27.

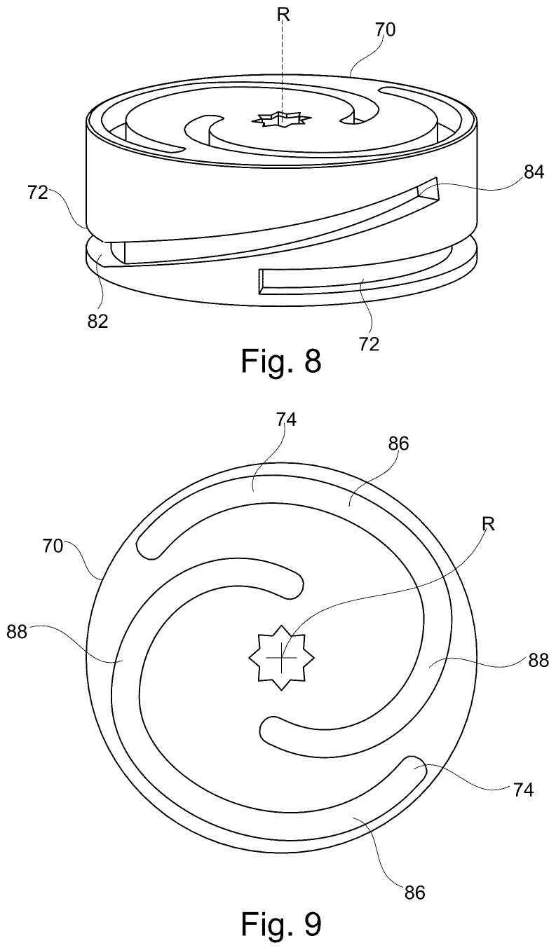

The function of the coupling element 62 is also discussed below with reference to FIGS. 8 and 9. FIG. 8 shows a perspective individual part view of the coupling element 70 and FIG. 9 shows a top view of the same.

Referring first to the control contours 72 on the lateral surface of a cylinder 76, it can be seen that these each have a slope-free section 82 which has no slope along the rotation axis R, as well as a section 84 which rises along the rotation axis R. Both sections 82, 84 extend in an angular range of approximately 120° around the rotation axis R. The rising section 84 is not visible for the right control contour 82 in FIG. 8, since it is located on the side of the lateral surface of a cylinder 76 facing away from the observer. In order to enable sufficient lowering with a compact design of the holding apparatus 10, the rising sections 84 have, for example, an angle of slope of between 5° and 25°, for example between 10° and 15° and in particular approximately 11°. They bridge a height difference of between 10 mm and 30 mm, for example between 15 mm and 20 mm, in particular approx. 16 mm.

As long as the coupling webs 27 of the support element 22 are located in the slope-free section 82 and are supported thereon, the support element 22 remains in its position along axis A of FIG. 6. However, when the coupling webs 27 reach the rising sections 84, the position along axis A of FIG. 6 changes.

The positions of the coupling webs 27 along the respective control contours 72 are always similar, i.e., the coupling webs 27 are always located at comparable positions within the control contours 72, in particular simultaneously in the slope-free section 82 or in the rising section 84. In the example shown, this is achieved by the control contours 72, which are in principle of the same shape, being suitably positioned relative to one another, and in particular suitably distributed relative to one another about the rotation axis R. More specifically, a rotation of one of the control contours 72 by 180° around the rotation axis R would result in a congruent reproduction on the corresponding other control contour 72

FIG. 9 shows the control contours 74 into which the holding elements 24 engage and thereby support themselves on them. The control contours 74 each have a section 86 with a uniform distance from the rotation axis R, i.e., with a uniform radius, and a section 88 with a decreasing distance from the rotation axis R, i.e., with a decreasing radius. A difference between these radii and in particular a difference to the smallest local radius of the section 88 can be, for example, between 10 mm and 40 mm, for example between 20 mm and 30 mm, in particular approximately 22 mm. Both sections 86, 88 extend in an angular range of approximately 120° around the rotation axis R. The reduction in radius of sections 88 takes place preferably linear along their length, so that correspondingly linear movements of the holding elements 24 can be generated.

As long as the holding elements 24 are supported in section 86 with a uniform distance or radius, no movement occurs along axis B. Such a movement only occurs when they are supported within sections 88 with a decreasing distance or radius. Again, the holding elements 24 are always supported at similar positions within the control contours 74 and are thus moved in a similar manner relative to one another. This in turn results from a suitable relative arrangement of the control contours 74, which in principle have the same design, around the rotation axis R.

An advantage of the sections 88 with decreasing radius and the rising sections 84 is that self-locking effects can be achieved with each of these. This makes it more difficult for the coupling element 70 to twist when force is applied by the support element 22 or the holding elements 24, e.g. as a result of manual incorrect operation.

In the original state shown in FIG. 6, the coupling webs 27 of the support element 22 are supported on the outermost ends of the rising sections 84. The support element 22 is therefore raised to its maximum. The holding elements 24 are supported at the outermost ends of the sections 86 at equal distances. The coupling element 70 is then rotated about the rotation axis R in such a direction that the coupling webs 27 of the support element 22 are moved along the rising sections 84 in the direction of the slope-free sections 82. This results in a lowering of the support element 22 along axis A, which runs parallel to the rotation axis R or coincides therewith.

During this, the holding elements 24 and more precisely their pin-like projections 80 remain within the sections 86 at a constant distance from the rotation axis R, so that no movement of the holding elements 24 is generated. However, the pin-like projections 80 move in the direction of sections 88 with a decreasing distance.

After a rotation of the coupling element 70 by 120°, the coupling webs 27 (or their projections 80) of the support element 22 reach the slope-free sections 82. At the same time, the projections 80 of the holding elements 24 reach the sections 88 with a decreasing distance or radius. If the coupling element 70 continues to rotate in the same direction, the coupling webs 27 are moved along the slope-free sections 82 so that the support element 22 remains in its lowered, lowest position. On the other hand, the projections 80 of the holding elements 24 are moved along the sections 88 with decreasing radius, so that the holding elements 24 are moved towards one another and in overlap with the support surface 23. In this way, a mobile device lying on the lowered support surface 23 can be clamped between the holding elements 24 and thereby held in the holding apparatus 10.

To release the mobile device, the coupling element 70 is rotated in the opposite direction, whereupon a correspondingly reversed movement sequence of the holding elements 24 of the support element 22 results until the resting state of FIG. 6 is reached again.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A holding apparatus for holding a mobile device in a vehicle interior, the holding apparatus comprising:
a support element having a support surface for supporting the mobile device, wherein the support element is movable along a first axis between a raised position and a lowered position;
at least one holding element for reversibly holding and releasing the mobile device, wherein the at least one holding element is movable along a second axis between a holding position for holding the mobile device and a release position for releasing the mobile device; and
a drive device configured to move the support element along the first axis and the at least one holding element along second axis.

2. The holding apparatus according to claim 1, wherein in the holding position the at least one holding element overlaps at least sectionally with the support surface of the support element.

3. The holding apparatus according to claim 1, wherein at least one of: i) the second axis extends at an angle to the first axis or ii) the at least one holding element is translationally movable.

4. The holding apparatus according to claim 3, wherein the angle is between at least 10° and up to 135°.

5. The holding apparatus according to claim 1, wherein the at least one holding element comprises at least one coupling section for coupling to the drive device, wherein the at least one coupling section overlaps with a rear side of the support element facing away from the support surface, at least when the holding position is assumed.

6. The holding apparatus according to claim 1, wherein the holding apparatus further comprises:
a frame element with a front side facing the vehicle interior, wherein at least one of: i) the support element is arranged flush with the front side of the frame element or ii) the frame element extends adjacent to at least two sides of the support element or encloses the support element in a frame-like manner.

7. The holding apparatus according to claim 6, wherein at least one section of the frame element is opposite the support element such that the support element is supported on this section during movement along the first axis with reversible deformation of the frame element at least in some areas.

8. The holding apparatus according to claim 1,
wherein the at least one holding element, viewed along the second axis, comprises a first end section which, when moved along the second axis, is movable relative to an adjacent region of the holding apparatus, wherein, at least when the release position is assumed, the first end section and the adjacent region can be received into one another at least sectionally.

9. The holding apparatus according to claim 8, wherein the first end section and the adjacent region are complementary shaped at least sectionally.

10. The holding apparatus according to claim 9, wherein the complementary shaped sections of the first end section and the adjacent region each have a toothing.

11. The holding apparatus according to claim 1, wherein the drive device comprises an electric motor for generating movement of both the support element and the at least one holding element, wherein the electric motor is configured to rotate a coupling element, and wherein the coupling element is coupled to both the support element and the at least one holding element.

12. The holding apparatus according to claim 11, wherein at least one of one of the coupling element or the support element has a first control contour on which the corresponding other of the support element or the coupling element is supported, wherein one of the coupling element or the at least one holding element has a second control contour on which the corresponding other of the at least one holding element or the coupling element is supported, and wherein the first control contour and the second control contour, in accordance with a rotation of the coupling element, generate one or more movement forces for moving the corresponding one of the support element and the at least one holding element.

13. The holding apparatus according to claim 11, wherein the coupling element, at a first surface thereof, is coupled to the at least one holding element and, at a second surface thereof, is coupled to the support element.

14. The holding apparatus of claim 13, wherein the coupling element is circular-cylindrical and wherein the first surface is a cylinder base area and the second surface is a lateral surface of a cylinder.

15. The holding apparatus according to claim 1, further comprising:
a sensor arrangement having:
at least one first sensor, wherein the at least one first sensor is configured to generate one or more measurement signals indicating whether a user wants to at least one of insert the mobile device into the holding apparatus or remove the mobile device from the holding apparatus; and
at least one second sensor configured to generate one or more second measurement signals indicating whether the mobile device is present in the holding apparatus.

16. The holding apparatus of claim 15, wherein the at least one first sensor includes a proximity sensor.

17. The holding apparatus according to claim 1, further comprising:
a covering skin with a front side facing the vehicle interior and a rear side facing away from the vehicle interior, wherein the covering skin conceals at least the support element with respect to the vehicle interior and is connected thereto for a common movement.
